(19) United States
(12) Patent Application Publication
(10) Pub. No.: US 2007/0075661 A1
(43) Pub. Date: Apr. 5, 2007

(54) Winding Control Improvement of Drive Motor for Hybrid Electric Vehicle

(75) Inventor: John S. Hsu, Oak Ridge, TN (US)

Correspondence Address: UT-Battelle, LLC;Office of Intellectual Property, One Bethal Valley Road, 4500N, MS-6258, Oak Ridge, TN, 37831, US

(73) Assignee: UT-BATTELLE, LLC, Oak Ridge, TN (US)

(21) Appl. No.: 11/463,984

(22) Filed: Aug. 11, 2006

Related U.S. Application Data
(60) Provisional application No. 60/596,564, filed on Oct. 4, 2005.

(51) Int. Cl. H02P 7/06

(52) U.S. Cl. 318/254

(57) ABSTRACT

This invention uses winding connection control and bidirectional on/off switches to supply reasonable level voltage to a motor without a booster. This invention also can raise the speed of the motor to double (or higher) of its original speed in order to free up the rooms in the slots for the additional winding. Besides lowering the battery requirement at starting, this invention can also increase the energy recovery when decelerating at low speed due to the additional turns of the motor winding-2 that produces higher voltage at low speed for charging the battery, hence higher miles per gallon.

### CROSS-REFERENCE TO RELATED APPLICATIONS

This application claims priority to U.S. Provisional Patent Application 60/596,564 filed Oct. 4, 2005, and is herein incorporated by reference.

### STATEMENT REGARDING FEDERALLY SPONSORED RESEARCH

This invention was made with United States Government support under Contract No. DE-AC05-00OR22725 between the United States Department of Energy and U.T. Battelle, LLC. The United States Government has certain rights in this invention.

### BACKGROUND OF THE INVENTION

The battery of a hybrid electric vehicle is an expensive item. It is an energy storage device that stores the energy when the vehicle is decelerated and releases energy when accelerated.

FIG. 1 shows the Prius on-road test results of full acceleration. This figure was originally published by Masaki Okamura, Eiji Sato, and Shoichi Sasaki of Toyota Motor Corporation. The time scale was later added by the Nanyang University.

The battery is the sole energy source at starting. For example at starting the electric motor torque of the Toyota/Prius motor is 400 Nm. Testing has shown that roughly 300 amps of motor current magnitude is required to produce the torque. The Prius battery is around 20 kW at 200+ volts that gives a nominal current of about 100 amps. The 300 amps of motor current magnitude are an over load to the battery within a duration of few seconds.

In order to reduce the high battery-current demand during starting, one existing technology is to increase the motor number of turns. The motor supply voltage has to be boosted at high speed in order to balance the higher back emf (electro motive force) associated with the higher number of turns. This technology requires a high-voltage inverter that requires high-voltage switching devices, capacitors, and other inverter components. The supply voltage of this technology is high. The motor winding has to be able to withstand the high voltage stress when the starting current is low for producing the sufficient torque. There is a limitation on the voltage magnitude due to the insulation limit, hence the reduction limit of the starting current that is provided by the battery. The invention herein that uses winding connection control is a solution to the problem.

### BRIEF SUMMARY OF THE INVENTION

A motor winding control device for vehicle drive motors is taught. The motor winding control device has an electric motor with a plurality of winding combinations capable of being switched into or out of the current path through the motor. It also has a plurality of switches capable of switching the current path through the winding combinations. A means for controlling the plurality of switches wherein the winding combinations are activated and deactivated according to predetermined settings, for example, computer controlled switches.

### BRIEF DESCRIPTION OF THE DRAWINGS

FIG. 1 is a graph of the Prius on-road test results for full acceleration.

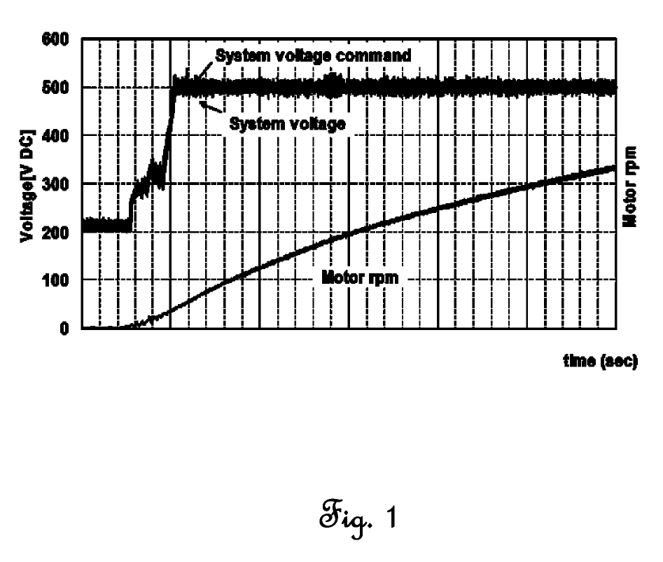

FIG. 2 is a connection diagram of winding switches for two-fixed-turn selections.

FIG. 3 is a diagram of connection options on FIG. 2.

FIG. 4 is a diagram showing additional switches introduced in winding-2 for voltage stress reduction.

FIG. 5 is a connection diagram of winding switches for three-fixed-turn selections.

FIG. 6 is a connection diagram of winding switches for four-fixed-turn selections.

FIG. 7 is a connection diagram of winding switches for two-fixed-turn selections of a delta connection.

### DETAILED DESCRIPTION OF THE INVENTION

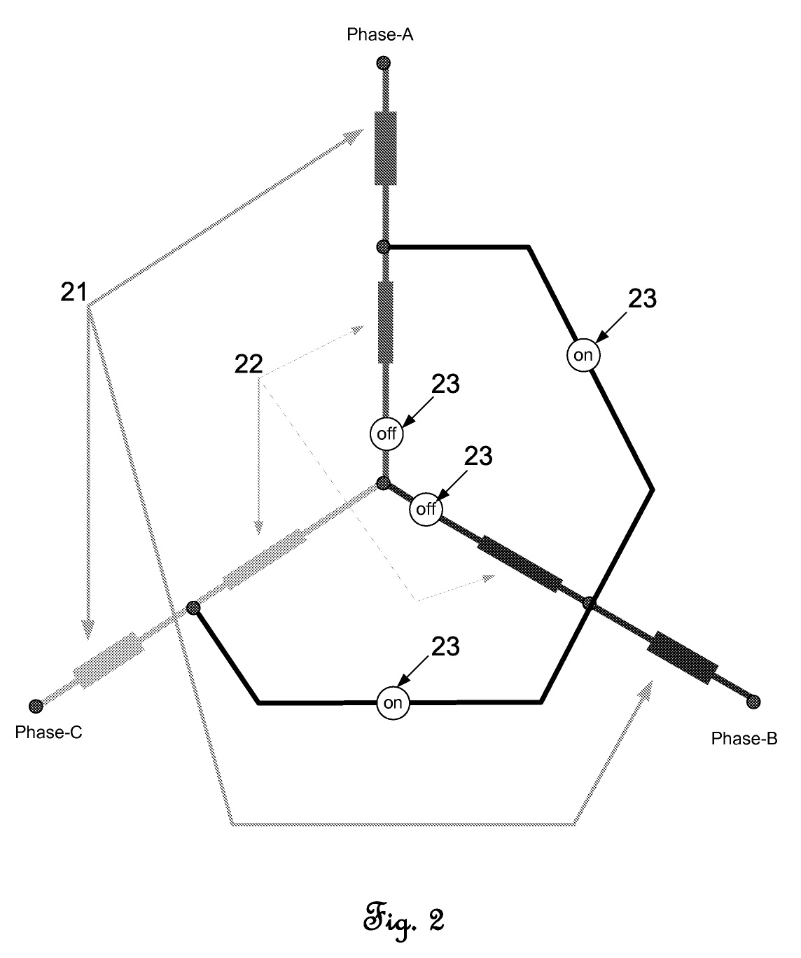

The supply voltage to the motor can be maintained at a reasonable level without a booster. The voltage stress in the windings can also be controlled. FIG. 2 shows a connection diagram of winding switches for two-fixed-turn selections. For each phase the winding has winding-1 21 and winding-2 22. Winding-2 22 has thinner conductors for the initial starting and accelerating the motor. Winding-1 21 is a higher current winding that operates alone without the winding-2 22 in circuit after the very initial starting and accelerating are over.

The bidirectional on/off switches 23 can be power-electronic switches, such as thyristors, as well as mechanical switches that include liquid-metal switches and others. The cost of silicon dies is coming down rapidly. Therefore, the use of power electronic on/off switches at low frequency may be practical.

The on/off switches 23 in FIG. 2 show in the “on” position that the neutral of the Y-connected winding is connected to the winding-1 21 of the 3-phase motor. The on/off switches in the “off” position indicate that the winding-2 22 is not connected to a neutral point and is out of the current-carrying circuit of the motor. When the switches in FIG. 2 are toggled to their opposite on/off positions, the winding-2 22 and winding-1 21 of each phase are connected in series. The neutral is connected to the winding-2 22 of all three phases. There are more turns in each phase due to the series winding connection. Consequently, the starting current required from the battery for producing the sufficient torque is reduced. The battery current reduction depends on the turn ratio of

$$\frac{Number of turns of winding - 1}{\begin{matrix}( Number of turns of winding - 1 + \\ Number of turns of winding - 2 )\end{matrix}}$$

This equation says that higher number of turns of winding-2 22 reduces the current magnitude that has to be provided by the battery.

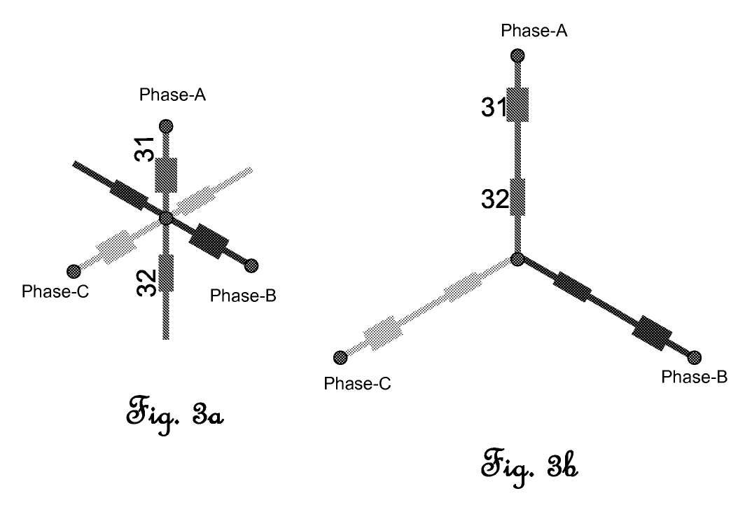

FIG. 3 shows the two connection options of the diagram shown in FIG. 2. The ratio of voltage in winding-2 32 to the voltage in winding-1 31 when winding-2 32 is out of circuit as shown in FIG. 3a is:

$$\frac{( Number of turns of winding - 2 )}{( Number of turns of winding - 1 )}$$

For example if the numbers of turns in the two windings are the same, the winding 2 32 voltage equals winding-1 31 voltage. This may ease the high voltage situation. Most switches are only toggled at low speed when the induced voltage from the permanent magnets is low.

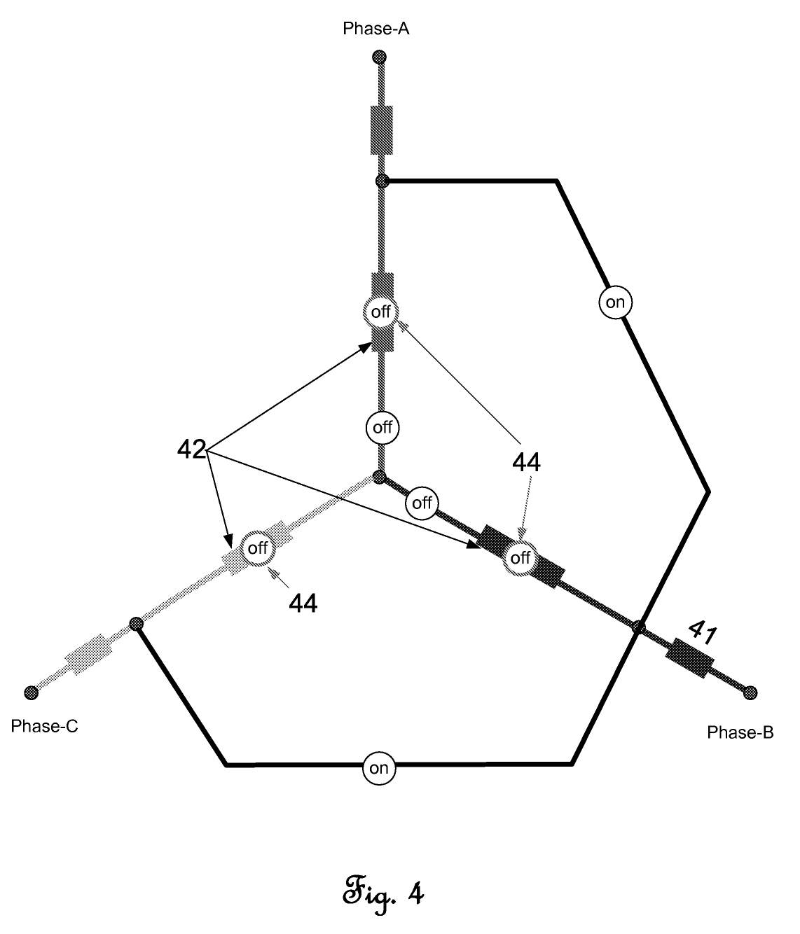

FIG. 4 shows when the number of turns of winding-2 42 is very high, the insulation stress of winding-2 42 reaches to an unacceptable level. Referring to FIG. 2 as an example, additional on/off switches 44 may be used as shown in FIG. 4 to break the winding-2 42 into sections. Consequently, no over-voltage-stress problems exist. This is very different from the voltage-boosting technology current used by the Toyota/Prius hybrid vehicles, because this invention can solve the high winding-voltage-stress problem by switches to break the winding in sections and the Prius technology cannot when the number of turns is high for the situation of further reduction of battery current during starting.

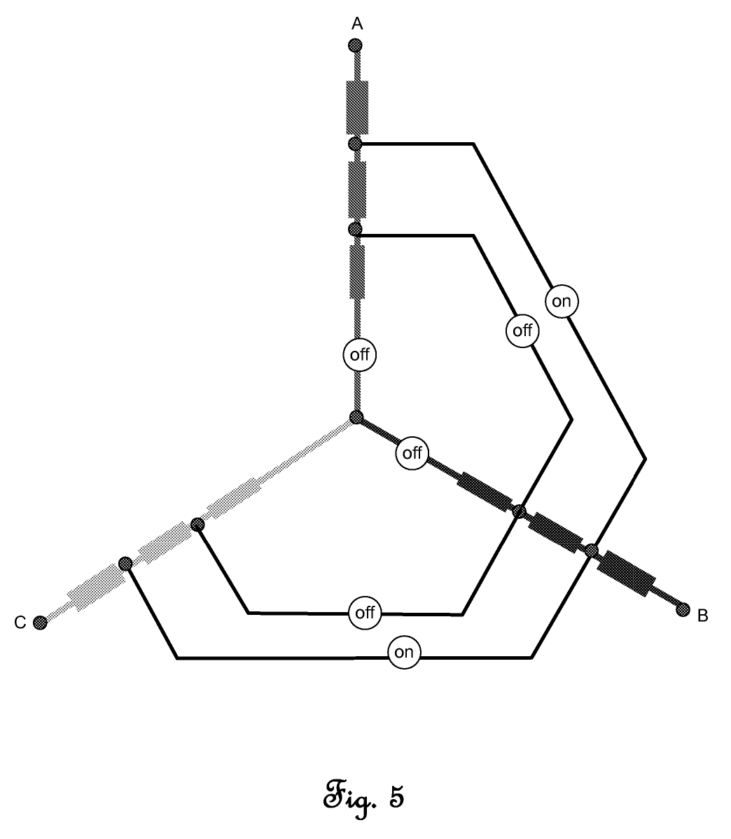

FIG. 5 shows the connection diagram of winding switches for three fixed-turn selections. The number, N, of fixed-turn selections can be any number. From FIG. 2 of two fixed-turn selections (N=2) the required number of switches is 4. From FIG. 5 of N=3 the required number of switches is 6. We have the relationship between the number of fixed-turn selections, N, and the required number of switches:
(Required number of switches)=2N

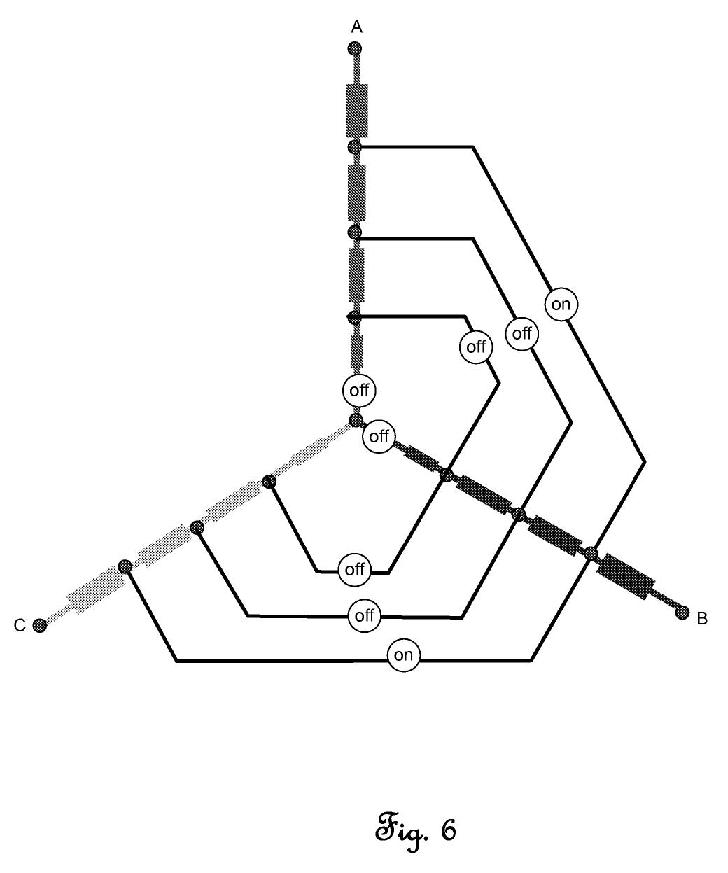

FIG. 6 confirms that if N=4 the required number of switches is eight.

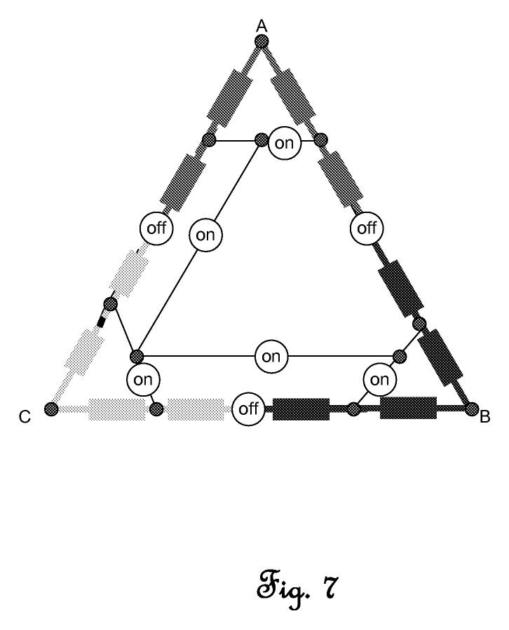

FIG. 7 shows that for delta connections the required number of switches would be higher. The delta-connections are relatively complex than those of the Y-connections.

For an existing drive motor, if one does not want to increase the motor size, it may be possible to raise the speed of the motor to double (or higher) of its original speed in order to free up the rooms in the slots for the additional winding. Besides lowering the battery requirement at starting, this technology can also increase the energy recovery when decelerating at low speed due to the additional turns of the motor winding-2 that produces higher voltage at low speed for charging the battery, hence higher miles per gallon.

While there has been shown and described what are at present considered the preferred embodiments of the invention, it will be obvious to those skilled in the art that various changes and modifications can be made therein without departing from the scope.

I claim:

1. A motor winding control device comprising;
an electric motor comprising a plurality of winding combinations capable of being switched into or out of the current path through said motor,
a plurality of switches capable of switching said current path through said winding combinations,
a means for controlling said plurality of switches wherein said winding combinations are activated and deactivated according to predetermined settings.

2. The device of claim 1, wherein said plurality of winding combinations comprises at least two fixed turn windings.

3. The device of claim 2, wherein said fixed turned windings are Y-connected.

4. The device of claim 2, wherein said fixed turned windings are delta connected.

5. The device of claim 1, wherein said motor is a three phase motor.

6. The device of claim 5, wherein said motor is a permanent magnet direct current motor.

7. The device of claim 5, wherein said motor is a synchronous motor.

8. The device of claim 5, wherein said motor is a reluctance motor.

9. The device of claim 5, wherein said motor is an induction motor.

10. The device of claim 6, wherein said motor is brushless.

11. The device of claim 6, wherein said motor is electrically commutated.

12. The device of claim 1, wherein said switches are bidirectional on/off switches.

13. The device of claim 12, wherein said switches are selected from the group consisting of power electronic switches, thyristors, mechanical switches, and liquid metal.

14. The device of claim 1, wherein a portion of said plurality of switches are positioned to break individual windings into sections.

15. The device of claim 1, wherein said means for controlling further comprises a computer.
